(19) United States
(12) Patent Application Publication
(10) Pub. No.: US 2014/0041189 A1
(43) Pub. Date: Feb. 13, 2014

(54) VISOR INSTALL FIXTURE

(71) Applicant: Michael J. Benedict, Trussville, AL (US)

(72) Inventor: Michael J. Benedict, Trussville, AL (US)

(73) Assignee: HONDA MOTOR CO., LTD., Toyko (JP)

(21) Appl. No.: 13/572,935

(22) Filed: Aug. 13, 2012

(51) Int. Cl. B60J 3/02

(52) U.S. Cl. CPC B60J 3/0204
USPC 29/428; 29/281.5

(57) ABSTRACT

A device that aids and eases the installation of an instrument panel visor on a vehicle and the installation method using the device. The device forms an inner gap having protective pads that conforms to a surface contour of the visor. The device is temporarily and removably installed on the visor during the installation of the visor in an vehicle body, such that the installer can hammer on the device, such as by using a fist, to push the visor into place and complete installation, after which the device is removed from the visor for reuse in installing another visor in another vehicle body.

### BACKGROUND

This application relates generally to a tool for aiding in the assembly of parts of a product, and more specifically, this application relates to a device that aids and eases the installation of an instrument panel visor on a vehicle.

An instrument panel visor is provided with an automobile display or navigation system to shield displays of the system from ambient light and to provide a pleasing look to the interior of the vehicle. However, installation of this visor often requires more effort than expected. The installation process may result in unsatisfactory physical impact on the installing employee, and an increase in miss-sets can reduce product quality. Accordingly, an installation approach that would mitigate one or more of these problems is desirable.

### SUMMARY

Provided are a plurality of example embodiments of the invention, including, but not limited to, device for supporting the installation of a vehicle visor in a vehicle, comprising a main body having a first part and a second part, the main body forming an inner gap such that the first part forms a part of the inner gap that follows a contour of a part of the vehicle, and such that the lower part forms another part of the inner gap that follows a contour of a part of the vehicle visor. The device also comprising at least one protective pad, the at least one protective pad being provided on the first part of the main body in the inner gap and on the second part of the main body in the inner gap. The at least one protective pad is provided of a material that protects a surface of the vehicle visor and the part of the vehicle from damage during the installation of the vehicle visor, and distributes a force applied to the main body to the vehicle visor for performing the installation of the vehicle visor. The device is adapted to be removably installed on the vehicle visor during the installation of the vehicle visor, and the device is further adapted to be removed from the vehicle visor after the installation of the vehicle visor.

Also provided is device for supporting the installation of a vehicle visor in a vehicle, comprising a main body formed of a rigid material and having a first part and a second part, the main body forming an inner gap substantially conforming to a surface contour of the vehicle visor, such that the first part forms a part of the inner gap that follows a contour of a part of the vehicle, and such that the second part forms another part of the inner gap that follows a contour of a part of the vehicle visor. The device also comprising a plurality of protective pads each being made with a compliant surface, at least one of the protective pads being provided on the first part of the main body in the inner gap for conforming its compliant surface to a first portion of the contour of the part of the vehicle, and at least one other of the protective pads being provided on the second part of the main body in the inner gap for conforming its compliant surface to a second portion of the contour of the part of the vehicle visor. The device further comprising a comfort pad including a compliant material provided on a substantially flat portion of an outer surface of the main body, the comfort pad being adapted for softening an installing force from a hand of an assembler installing the vehicle visor for providing the installing force. The device is adapted such that the protective pads distribute the installing force to the vehicle visor without damage to the vehicle visor, and the device is adapted to be removably installed on the vehicle and vehicle visor during installation of the vehicle visor. The device is further adapted to be removed from the vehicle and the vehicle visor after installation of the vehicle visor.

Still further provided is a method of installing an vehicle visor, such as using a visor install fixture including either of the above devices, the method comprising the steps of placing the vehicle visor in a preliminary position; installing a visor install fixture on the vehicle visor, such that a portion of an inner gap of the visor install fixture conforms to a surface contour of a portion of an outer surface of the vehicle visor; applying a force to an outer surface of the visor install fixture to position the vehicle visor in an installation location; securing the vehicle visor at the installation location; and removing the visor install fixture from the vehicle visor after securing the vehicle visor.

Further provided is a method of installing a vehicle visor on a vehicle, comprising the step of providing a visor install fixture including: a main body formed of a rigid material, the main body having a surface forming the inner gap, such that a portion of the inner gap substantially conforms to a corresponding portion of the surface contour of the vehicle visor, including at least one protective pad being provided on the surface of the main body forming the portion of the inner gap, including a comfort pad including a compliant material provided on an outer surface of the main body, the comfort pad being adapted for softening an installing force from a hand of an assembler installing the vehicle visor, with the at least one protective pad being provided of a compliant material that protects the outer surface of the vehicle visor from damage during the installation and removal of the visor install fixture from the vehicle visor.

The above method also including the steps of placing the vehicle visor in a preliminary position; installing the visor install fixture on the vehicle visor, such that the portion of an inner gap of the visor install fixture substantially conforms to the surface contour of the portion of the outer surface of the vehicle visor; applying the installing force to the comfort pad of the visor install fixture to position the vehicle visor in an installation location; securing the vehicle visor at the installation location; and removing the visor install fixture from the vehicle visor after securing the vehicle visor.

Also provided are additional example embodiments, some, but not all of which, are described hereinbelow in more detail.

### BRIEF DESCRIPTION OF THE DRAWINGS

The features and advantages of the example embodiments described herein will become apparent to those skilled in the art to which this disclosure relates upon reading the following description, with reference to the accompanying drawings, in which:

FIG. 1 shows a side view of an example visor install fixture;

FIG. 2 shows a perspective view of the example visor install fixture;

FIG. 3 shows an installation setup that does not utilize the visor install fixture;

FIG. 4 shows an installation setup utilizing the visor install fixture; and

FIG. 5 is a flow chart describing a simplified visor installation procedure using the visor install fixture.

### DETAILED DESCRIPTION OF THE EXAMPLE EMBODIMENTS

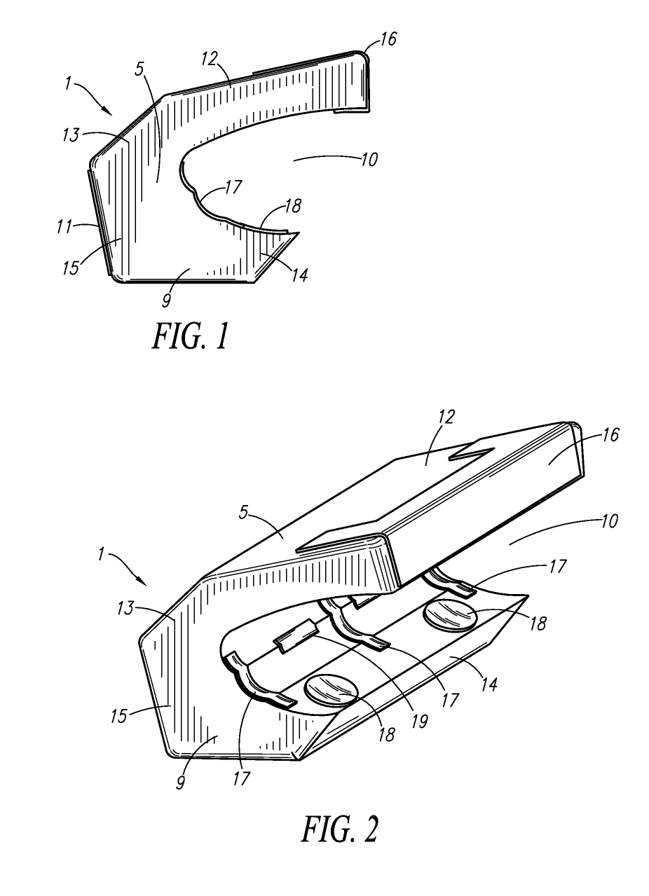

The visor install fixture device of FIGS. 1-2 was conceived in order to reduce the installation effort of, and ease physical strain on, an installer performing an installation procedure for installing an instrument panel display or navigation visor (or even some other similar component) in a vehicle. This device is generally designed to conform to the surface contours of the visor for temporary use during the installation of the display visor into the vehicle.

As shown in FIGS. 1-2, the visor install fixture 1 has a main body 5 that is generally “C” shaped in cross section with an upper part 12, a corner part 13, a back part 15, and a lower part comprising a bottom part 9 and lower lip 14, all of which in cooperation form an inner gap 10 that is arranged to conform to the outer surface shape of a visor 21 in conjunction with the top of the instrument panel 20 (such as in the manner shown in FIG. 4).

The width of the visor install fixture 1 is sufficient to allow the installer to hold the device as shown in FIG. 4, with sufficient space to strike the visor install fixture 1 with a hand or tool. The depth of the visor install fixture 1 is sufficient so that the device properly grips the visor/instrument panel 21, 20 in a secure manner during installation, and sufficiently distributes the installation force over the visor to avoid damage to the visor.

The main body 5 of the visor install fixture 1 that forms the upper part 12, the corner part 13, the back part 15, the bottom part 9, and lower lip 14 can be comprised of a relatively strong, lightweight material such as wood, plastic, composite, or other similar material that is relatively rigid, holds its shape under use, and is preferably lightweight. The main body 5 may be hollow to further reduce its weight, in which case an acceptable material might be even heavier weight material such as aluminum or another metal alloy, or a dense plastic or composite material. The device could be formed in a mold, for example, or machined in a machine shop.

Referring again to FIGS. 1-2, the visor install fixture 1 is provided with a number of protective pads 16, 17, 18, and 19 to protect the surface finish of the instrument panel 20 and the surface of the visor 21 being installed, but that also act to ensure that the visor install fixture 1 grips the visor in a sufficiently secure manner to enable the installation process and distribute the installation force. Such protective pads can include horizontal pads 19, vertical pads 17, and round pads 18, for example. Furthermore, more complex padding can be provided such as the upper edge pad 16. This padding works in concert to avoid damage to the visor install fixture 1 during the installation process. Instead of several individual protective pads, the device may be provided with one protective pad or padding with varying thicknesses and textures and that covers the entire area or specific areas of the device.

The protective pads 16, 17, 18, and 19 are preferably of a soft or otherwise resilient, compliant material that does not leave scuff marks on the instrument panel 20 or the visor 21, but that provides conforms to the contacting surfaces and provides sufficient grip on the visor such that it stays in place during the installation process. Materials that can be used for these protective pads include felt, rubber, foam, cloth, a soft plastic (that might include bristles or other surface features to soften the surface), or other material with the desired properties (soft and/or pliant that can avoid scuffing and sticking). It is not necessary that the same material be used for all of the pads, as in some situations different materials for different pads might be desirable.

These protective pads 16, 17, 18, and 19 could be attached to the main body through the use of an adhesive, such as glue, for example, or they might be spot welded (by melting a portion of each pad into the main body, for example). The protective pads might also be attached using a fastener such as a staple or tack, although this may be less desirable for providing a risk of scratching the instrument panel 20 or the visor 21 during use.

A comfort pad 11 is provided on a flat outer surface of the back part 15, although this surface could be provided slightly curved or polygonal as well as long as it is substantially flat or has a relatively large effective radius of curvature. The function of the comfort pad 11 is described in more detail hereinbelow, but is generally provided for the comfort and protection of the hands of the installer or assembler during the installation of the visor 21.

This comfort pad 11 might be made of a similar material discussed above for the protective pads 16, 17, 18, and 19, but alternative materials might also be utilized, as the problem of scuffing is not an issue for this comfort pad, as it will not be provided in contact with the instrument panel 20 or the visor 21 in normal use. Furthermore, added softness, texture, and/or thickness when compared to the protective pads might be desirable for greater assembler hand comfort. This comfort pad 11 can be attached to the main body 5 using any of the methods listed above for the protective pads, but there is no requirement that it use the same method of attachment as used for the protective pads.

For both the current and improved installation process, an assembler receives a vehicle body and a visor for installation. After installation, the vehicle body with visor installed is removed, and the assembler receives a new vehicle body and visor to repeat the installation process. Down the line, the installation of the visor may be quality checked to ensure proper installation, and any needed adjustments may be performed.

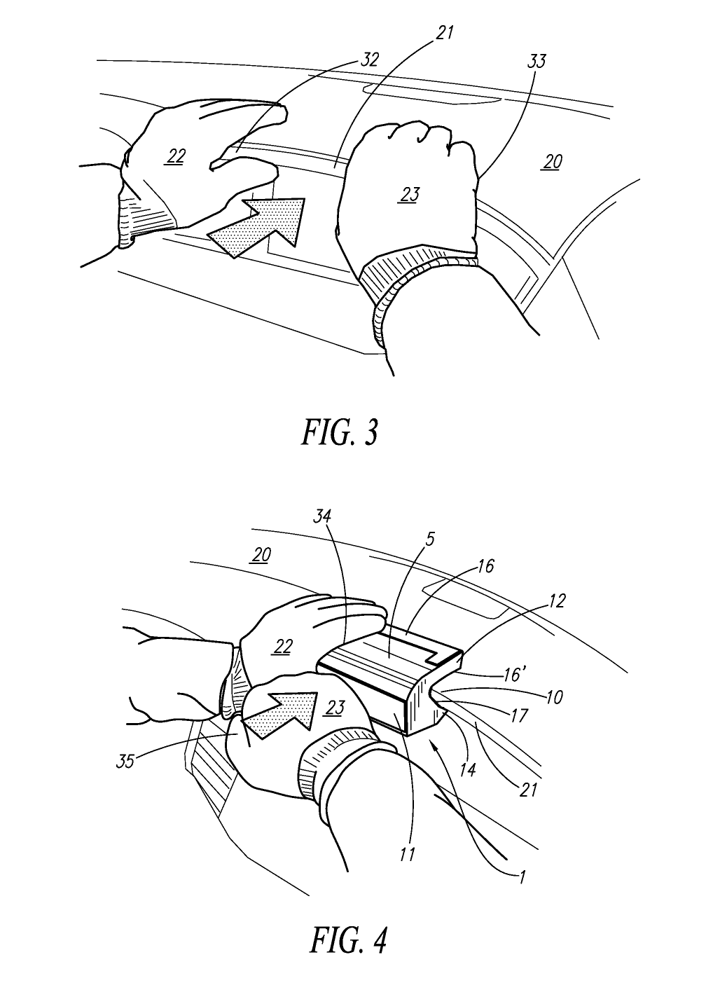

FIG. 3 shows a current installation setup for installing the visor 21 in a vehicle body (not shown) without use of the visor install fixture 1. To install the visor 21, the assembler grips the visor 21 at an edge with the left hand 22 and the right hand 23, at grip points 32 and 33, respectively. The assembler places the visor 20 in a desired position, and then pushes in the direction of the arrow to force the visor into place. The visor 21 is then fastened into place by action of mating devices that are not shown, but that typically automatically snap into place once properly mated. Alternatively, the visor 21 might be attached using fasteners (e.g., screws or rivets), or some other method.

However, this process requires that a physical force be applied by the assembler to push the visor 21 into place, in some cases requiring the application of almost 30 pounds of force for example. Such a force may put a strain on the hands 22, 23 of the assembler, particularly at the thumbs of the hand where the visor 21 is in contact with the hands. Such strain is not desirable when it can be avoided.

The visor install fixture 1 can be used to substantially reduce the strain on the assembler's hands during the visor installation process. FIG. 4 shows an example installation setup for the visor of FIG. 3 using the example visor install fixture 1 of FIGS. 1-2.

In this case, the visor 21 is put into a preliminary position near its installation point, and the visor install fixture 1 is slipped onto the instrument panel 20 and the visor 21, with the inner gap 10 substantially conforming to the surface contour of the instrument panel 20 and the visor 21 but with the protective pads (items 17-19 in FIGS. 1-2) in protective direct contact with the surface of the visor 21 and thereby avoiding any damage or scuffing to the visor. The upper edge pad 16 contacts the instrument panel 20 near a location 16′. The visor install fixture 1 basically conforms to the surface contours of the instrument panel 20 and the visor 21 with a relatively snug fit, with the protective pads in direct contact with the surfaces of the instrument panel and the visor, but the main body 5 not directly in contact with the visor surface, to protect the surface of the visor.

The installer holds the visor install fixture 1 in place with the left hand 22 at a grip point 34, and pushes, hits, or strikes (“hammers”) the visor install fixture 1 on the comfort pad 11 using the right hand 23 that is formed into a fist 35. The installer may also “hammer” the visor install fixture 1 on the comfort pad 11 using the right hand 23 that is in a neutral position, such as an open palm. This pushes the visor 21 into place, where it is secured to the vehicle in the same basic manner as for the installation process without use of the visor install fixture 1 (e.g., mating parts automatically mate to hold the visor in place). The visor install fixture 1 is then removed from the instrument panel 20 and the visor 21 for reuse for another visor installation.

The comfort pad 11 helps to protect the hands of the installer by cushioning or softening the “hammering” force from the hand of the installer. The installer may wear gloves 35, as shown in FIG. 4, to further protect the hands. Furthermore, the installer could utilize a mallet or other tool, rather than the right hand 23, to “hammer” the back part 15 of the visor install fixture 1 to push the visor 21 into place.

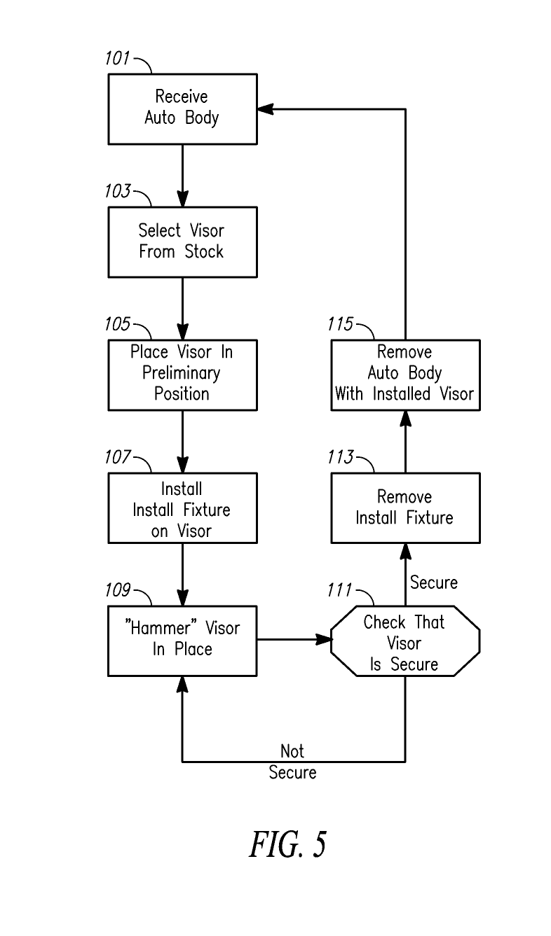

FIG. 5 is a simplified flow chart showing the major steps of this visor installation process. Basically, the installer receives a vehicle body 101 and selects or receives a visor 103 for installation. The visor is placed into position 105, and the visor install fixture is temporarily installed on the instrument panel/visor 107. The installer “hammers” the visor into place 109 using an installing force, such as by using his or her fist or open palm to hammer the visor install fixture. The installer checks to see that the visor is secure 111, such as by trying to pull it out or wiggle it. If the visor is not properly set, the installer can “hammer” the visor again to get it secure. Once secure, the visor install fixture is removed 113, and the vehicle body can be taken away 115. The process is then repeated with a new vehicle body and visor being provided.

This improved installation process puts less strain on the hands of the installer because the left hand 22 does not need to apply any significant force during the installation process, and the right hand 23 provides an installing force through a “hammering” process using a fist or palm that does not put any significant strain on the hands of the installer. Of course, the function of the hands can be switched, if desired, without any impact on the installation process.

Alternatively, the visor install fixture 1 could be provided on the visor 21 prior to putting the visor 21 in the preliminary position. Also, it is possible that the visor install fixture 1 could remain sufficiently in place on the visor 21 via gripping by the protective pads such that there is no need to hold visor install fixture 1 in place using the left hand 22 of the installer. The installer could then proceed with the “hammering” process using the fist or palm of one or both hands to provide the installing force.

This concept can also be used to install other similar components, such as other types of visors or dashboard components, by providing a visor install fixture adapted for those other components.

Many other example embodiments can be provided through various combinations of the above described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

What is claimed is:

1. A device for supporting the installation of a vehicle visor in a vehicle, comprising:
a main body having a first part and a second part, the main body forming an inner gap such that the first part forms a part of the inner gap that follows a contour of a part of the vehicle, and such that the lower part forms another part of the inner gap that follows a contour of a part of the vehicle visor; and
at least one protective pad, the at least one protective pad being provided on the first part of the main body in the inner gap and on the second part of the main body in the inner gap, wherein
the at least one protective pad is provided of a material that protects a surface of the vehicle visor and the part of the vehicle from damage during the installation of the vehicle visor, and distributes a force applied to the main body to the vehicle visor for performing the installation of the vehicle visor, and wherein
the device is adapted to be removably installed on the vehicle visor during the installation of the vehicle visor, and further wherein
the device is further adapted to be removed from the vehicle visor after the installation of the vehicle visor.

2. The device of claim 1, further comprising a comfort pad provided on a substantially flat portion of an outer surface of the main body, the comfort pad being adapted for softening a hammering force from a hand of an assembler installing the vehicle visor for providing the force.

3. The device of claim 1, wherein the at least one protective pad includes a compliant material that conforms to a corresponding portion of the contour of the vehicle visor.

4. The device of claim 3, wherein the compliant material is a felt or rubber material.

5. The device of claim 3, wherein the at least one protective pad is attached to the main body using an adhesive.

6. The device of claim 1, wherein the main body is comprised of a rigid material.

7. The device of claim 6, wherein the rigid material is comprised of a plastic, metal, or wood.

8. A device for supporting the installation of a vehicle visor in a vehicle, comprising:
a main body formed of a rigid material and having a first part and a second part, the main body forming an inner gap substantially conforming to a surface contour of the vehicle visor, such that the first part forms a part of the inner gap that follows a contour of a part of the vehicle, and such that the second part forms another part of the inner gap that follows a contour of a part of the vehicle visor;
a plurality of protective pads each being made with a compliant surface, at least one of the protective pads being provided on the first part of the main body in the inner gap for conforming its compliant surface to a first portion of the contour of the part of the vehicle, and at least one other of the protective pads being provided on the second part of the main body in the inner gap for conforming its compliant surface to a second portion of the contour of the part of the vehicle visor;
a comfort pad including a compliant material provided on a substantially flat portion of an outer surface of the main body, the comfort pad being adapted for softening an installing force from a hand of an assembler installing the vehicle visor for providing the installing force, wherein
the device is adapted such that the protective pads distribute the installing force to the vehicle visor without damage to the vehicle visor, and wherein
the device is adapted to be removably installed on the vehicle and vehicle visor during installation of the vehicle visor, and further wherein
the device is further adapted to be removed from the vehicle and the vehicle visor after installation of the vehicle visor.

9. A method of installing a vehicle visor on a vehicle using a visor install fixture including the device of claim 8, the method comprising the steps of:
placing the vehicle visor in a preliminary position in the vehicle;
installing the visor install fixture on the vehicle and vehicle visor;
applying a force to the outer surface of the visor install fixture to position the vehicle visor in an installation location;
securing the vehicle visor at the installation location; and
removing the visor install fixture from the vehicle visor.

10. The method of claim 9, wherein applying the force to the outer surface of the visor install fixture is done using at least one hand of an installer.

11. The method of claim 9, wherein applying the force to the outer surface of the visor install fixture is done using a fist of one hand of an installer while the visor install fixture is held in place using the other hand of the installer.

12. The method of claim 9, wherein the securing the vehicle visor is accomplished by one or more parts of the vehicle visor automatically mating with corresponding one or more parts of the vehicle during the applying the force step.

13. A method of installing a vehicle visor on a vehicle, the method comprising the steps of:
placing the vehicle visor in a preliminary position;
installing a visor install fixture on the vehicle visor, such that a portion of an inner gap of the visor install fixture conforms to a surface contour of a portion of an outer surface of the vehicle visor;
applying a force to an outer surface of the visor install fixture to position the vehicle visor in an installation location;
securing the vehicle visor at the installation location; and
removing the visor install fixture from the vehicle visor after securing the vehicle visor.

14. The method of claim 13, wherein the applying the force step includes hammering the outer surface of the visor install fixture using at least one fist of an installer.

15. The method of claim 13, wherein the applying the force step includes using a fist of one hand of an installer while the visor install fixture is held in place using the other hand of the installer.

16. The method of claim 13, wherein the securing the vehicle visor is accomplished by one or more parts of the vehicle visor automatically mating with corresponding one or more parts of the vehicle during the applying the force step.

17. The method of claim 13, wherein the visor install fixture comprises:
a main body formed of a rigid material, the main body having a surface forming the inner gap, such that a first portion of the inner gap substantially conforms to a corresponding portion of the surface contour of the vehicle visor, and wherein a second portion of the inner gap substantially conforms to a part of the vehicle;
at least one protective pad being provided on the surface of the main body forming the first portion of the inner gap;
at least one other protective pad being provided on the surface of the main body forming the second portion of the inner gap;
a comfort pad including a compliant material provided on a substantially flat portion of an outer surface of the main body, the comfort pad being adapted for softening the installing force from a hand of an assembler performing the applying a force step, wherein
the at least one protective pad and the at least one other protective pad are provided of a compliant material that protects the outer surface of the vehicle visor and the outer surface of the vehicle part from damage during the installation and removal of the visor install fixture from the vehicle visor.
